(19) United States
(12) Patent Application Publication
(10) Pub. No.: US 2014/0255824 A1
(43) Pub. Date: Sep. 11, 2014

(54) SULPHUR-CONTAINING CHAIN TRANSFER REAGENTS IN POLYURETHANE-BASED PHOTOPOLYMER FORMULATIONS

(71) Applicant: Bayer Intellectual Property GmbH, Monheim (DE)

(72) Inventors: Marc-Stephan Weiser, Leverkusen (DE); Friedrich-Karl Bruder, Krefeld (DE); Thoms Rölle, Leverkusen (DE); Thomas Fäcke, Leverkusen (DE); Dennis Hönel, Zulpich (DE); Horst Berneth, Leverkusen (DE)

(73) Assignee: Bayer Intellectual Property GmbH, Monheim (DE)

(21) Appl. No.: 14/350,703

(22) PCT Filed: Oct. 10, 2012
(86) PCT No.: PCT/EP2012/070078

§ 371 Date: Apr. 9, 2014

(30) Foreign Application Priority Data
Oct. 12, 2011 (EP) 11184772.9

(51) Int. Cl. G03C 1/73

(52) U.S. Cl. CPC G03C 1/73
USPC 430/2

(57) ABSTRACT

The present invention relates to photopolymer formulations comprising: matrix polymers (A), obtainable by reacting at least one polyisocyanate component (a) and one isocyanate-reactive component (b); a writing monomer (B); a photoinitiator (C) a catalyst (D); and a sulphur-containing chain transfer reagent (E). A holographic medium that contains a photopolymer formulation according to the invention or can be obtained by using it, the use of a photopolymer formulation according to the invention for manufacturing holographic media, and a method for producing a holographic medium by using a photopolymer formulation according to the invention are also subject matter of the invention.

The present invention relates to a photopolymer formulation comprising matrix polymers A), obtainable by at least a polyisocyanate component a) and an isocyanate-reactive component b) being reacted, a writing monomer B), a photoinitiator C) and a catalyst D). The invention further relates to a holographic medium containing a photopolymer formulation of the present invention or obtainable by use thereof, to the use of a photopolymer formulation of the present invention for producing holographic media and also a process for prodicing a holographic medium using a photopolymer formulation of the present invention.

Photopolymer formulations of the type mentioned at the beginning are known from WO 2011/054797 and WO 2011/067057. They can be used for producing holographic media. Visually visible holograms can be exposed in the holographic media. It is likewise possible to use them for producing holographically optical elements. Visual holograms include all holograms recordable by following methods known to a person skilled in the art. These include inter alia in-line (Gabor) holograms, off-axis holograms, full-aperture transfer holograms, white light transmission holograms (“rainbow holograms”), Denisyuk holograms, off-axis reflection holograms, edge-lit holograms and also holographic stereograms. Examples of optical elements are lenses, mirrors, deflectors, filters, scattering disks, diffraction elements, optical fibers, waveguides, projection disks and masks.

It is an important requirement of the applications mentioned, but especially in the case of transmission holograms and optical elements, that the holographic medium have high transparency following hologram exposure and fixing. To ensure this, it is especially polyurethane-based photopolymer formulations that can be used for producing the holographic media.

The necessary high transparency is achieved for example when using formulations for holographic data storage media as described in WO 2003/102959 and WO 2008/125229. Yet because holographic media are multiplexed from these photopolymer formulations (by writing multiple weak holograms in the same volume or in overlapping volumes), the degree of conversion achieved in each exposure step with regard to the free-radical photochemistry (polymerization of writing monomers) is only low. By contrast, a single exposure step is sufficient to fully react the complete photochemistry in holographic media useful not only for producing visually visible holograms but also holographically optical elements (HOEs). The result is a distinctly greater refractive index modulation, which is achieved by greater mass transfer in the medium and the construction of higher molar masses in the course of the polymerization of the writing monomers, i.e., the construction of larger polymers. Yet larger polymers are larger scattering sites for visible light. This leads to reduced transparency, sharpness and contrast on the part of the hologram. The scattered radiation is also problematic with regard to the use as holographically optical element. Therefore, high refractive index modulation and low adventitious light scattering are difficult to realize at one and the same time.

The problem addressed by the present invention was therefore that of developing a photopolymer formulation from which it is possible to produce holographic media in which holograms can be exposed with a high refractive index modulation and which have reduced scatter.

This problem is solved in relation to a photopolymer formulation of the type mentioned at the beginning when it comprises a sulphur-containing chain transfer agent E).

A sulphur-containing chain transfer agent herein is any compound which has at least a sulphur atom and at least a covalent bond homolytically cleavable with free-radical formation.

True, the use of sulphur-containing chain transfer agents in photopolymer formulations is described in principle in CN 101320208 and U.S. Pat. No. 4,917,977 A. However, these formulations are not polyurethane-based systems, so there is already a distinctly reduced transparency in the exposed media here and therefore no amelioration in scatter was achieved by using the additives. Moreover, these photopolymer formulations share the feature that only a latent image is formed in the holographic exposure of the medium. Thus, the hologram is not fully formed by the free-radical photopolymerization, but only in a heat-activated postprocessing step. Hence the photopolymers mentioned in the prior art differ fundamentally from those in the present invention.

In a preferred embodiment of the invention, the sulphur-containing chain transfer agent E) comprises one or more compounds selected from the group monofunctional thiols, multifunctional thiols, preferably primary thiols or at least difunctional secondary thiols, disulphides and thiophenols. It is likewise preferable when the sulphur-containing chain transfer agent E) comprises one or more compounds selected from the group mono-, di- and multifunctional primary thiols or at least difunctional secondary thiols, preferably mono-, di- and multifunctional aliphatic thiols having primary thio groups and even more preferably n-alkylthiols having 8 to 18 carbon atoms and also mercaptoesters of mono- and multifunctional aliphatic alcohols having 1 to 18 carbon atoms.

It is very particularly preferable when the chain transfer agent E) comprises one or more compounds selected from the group n-octylthiol, n-hexylthiol, n-decylthiol, n-dodecylthiol, 11,11-dimethyldodecane-1-thiol, 2-phenylethyl mercaptan, 1,8-dithionaphthalene, octane-1,8-dithiol, 3,6-dioxa-1,8-octanedithiol, cyclooctane-1,4-dithiol, 3-methoxybutyl 3-mercaptopropionate, 2-ethylhexyl thioglycolate, 2-ethylhexyl 3-mercaptopropionate, isooctyl thioglycolate, isotridecyl thioglycolate, glycol di(3-mercaptopropionate), glycol dimercaptoacetate, pentaerythritol tetrakis(mercaptoacetate), pentaerythritol tetrakis(mercaptopropionate), trimethylolpropane tris(2-mercaptoacetate), trimethylolpropane tris(3-mercaptopropionate), 1,4-bis(3-mercaptobutylyloxy)butane, 1,3,5-tris(3-mercaptobutyloxyethyl)-1,3,5-triazine-2,4,6(1H,3H,5H)-triones, pentaerythritol tetrakis(3-mercaptobutylate), 2,2′-[ethane-1,2-diylbis(oxy)]diethanethiol, 2,2′-oxydiethanethiol, 2-thionaphthol, mercaptobenzothiazole, 2-mercaptobenzoxazole, mercaptobenzimidazole, 4-methylbenzyl mercaptan, 2-mercaptoethyl sulphide, bis(phenylacetyl)disulphide, dibenzyl disulphide, di-tert-butyl disulphide, phenothiazine and triphenylmethanethiol.

In a further embodiment of the invention, the photopolymer formulation comprises 0.01 wt % to 1 wt % and preferably 0.1 wt % to 0.5 wt % of the sulphur-containing chain transfer agent E).

As polyisocyanate component a) there can be used any compounds well known per se to a person skilled in the art, or mixtures thereof, which on average contain two or more NCO functions per molecule. These can be aromatic, araliphatic, aliphatic or cycloaliphatic based. Monoisocyanates and/or unsaturation-containing polyisocyanates can also be used, in minor amounts.

Suitable examples are butylene diisocyanate, hexamethylene diisocyanate (HDI), isophorone diisocyanate (IPDI), 1,8-diisocyanato-4-(isocyanatomethyl)octane, 2,2,4- and/or 2,4,4-trimethylhexamethylene diisocyanate, the isomeric bis(4,4′-isocyanatocyclohexyl)methane and mixtures thereof having any desired isomer content, isocyanatomethyl-1,8-octane diisocyanate, 1,4-cyclohexylene diisocyanate, the isomeric cyclohexanedimethylene diisocyanates, 1,4-phenylene diisocyanate, 2,4- and/or 2,6-tolylene diisocyanate, 1,5-naphthylene diisocyanate, 2,4′- or 4,4′-diphenylmethane diisocyanate and/or triphenylmethane 4,4′,4″-triisocyanate.

It is likewise possible to use derivatives of monomeric di- or triisocyanates having urethane, urea, carbodiimide, acylurea, isocyanurate, allophanate, biuret, oxadiazinetrione, uretdione and/or iminooxadiazinedione structures.

Preference is given to using polyisocyanates based on aliphatic and/or cycloaliphatic di- or triisocyanates.

It is particularly preferable for the polyisocyanates of component a) to comprise di- or oligomerized aliphatic and/or cycloaliphatic di- or triisocyanates.

Very particular preference is given to isocyanurates, uretdiones and/or iminooxadiazinediones based on HDI, 1,8-diisocyanato-4-(isocyanatomethyl)octane or mixtures thereof.

Likewise useful as component a) are NCO-functional prepolymers having urethane, allophanate, biuret and/or amide groups. Prepolymers of component a) are obtained in a well-known conventional manner by reacting monomeric, oligomeric or polyisocyanates a1) with isocyanate-reactive compounds a2) in suitable stoichiometry in the presence or absence of catalysts and solvents.

Useful polyisocyanates a1) include all aliphatic, cycloaliphatic, aromatic or araliphatic di- and triisocyanates known per se to a person skilled in the art, it being immaterial whether they were obtained by phosgenation or by phosgene-free processes. In addition, it is also possible to use the well-known conventional higher molecular weight descendant products of monomeric di- and/or triisocyanates having a urethane, urea, carbodiimide, acylurea, isocyanurate, allophanate, biuret, oxadiazinetrione, uretdione or iminooxadiazinedione structure each individually or in any desired mixtures among each other.

Examples of suitable monomeric di- or triisocyanates useful as component a1) are butylene diisocyanate, hexamethylene diisocyanate (HDI), isophorone diisocyanate (IPDI), trimethyl-hexamethylene diisocyanate (TMDI), 1,8-diisocyanato-4-(isocyanatomethyl)octane, isocyanatomethyl-1,8-octane diisocyanate (TIN), 2,4- and/or 2,6-toluene diisocyanate.

The isocyanate-reactive compounds a2) for constructing the prepolymers are preferably OH-functional compounds. These are analogous to the OH-functional compounds described hereinbelow for component b).

The use of amines for prepolymer preparation is also possible. For example, ethylenediamine, diethylenetriamine, triethylenetetramine, propylenediamine, diaminocyclohexane, diaminobenzene, diaminobisphenyl, difunctional polyamines, such as, for example, the Jeffamine® amine-terminated polymers having number average molar masses of up to 10 000 g/mol and any desired mixtures thereof with one another are suitable.

For the preparation of prepolymers containing biuret groups, isocyanate is reacted in excess with amine, a biuret group forming. All oligomeric or polymeric, primary or secondary, difunctional amines of the abovementioned type are suitable as amines in this case for the reaction with the di-, tri- and polyisocyanates mentioned.

Preferred prepolymers are urethanes, allophanates or biurets obtained from aliphatic isocyanate-functional compounds and oligomeric or polymeric isocyanate-reactive compounds having number average molar masses of 200 to 10 000 g/mol; particular preference is given to urethanes, allophanates or biurets obtained from aliphatic isocyanate-functional compounds and oligomeric or polymeric polyols or polyamines having number average molar masses of 500 to 8500 g/mol. Very particular preference is given to allophanates formed from HDI or TMDI and difunctional polyetherpolyols having number average molar masses of 1000 to 8200 g/mol.

The prepolymers described above preferably have residual contents of free monomeric isocyanate of less than 1 wt %, particularly preferably less than 0.5 wt %, very particularly preferably less than 0.2 wt %.

In addition to the prepolymers described, the polyisocyanate component can of course contain further isocyanate components proportionately. Aromatic, araliphatic, aliphatic and cycloaliphatic di-, tri- or polyisocyanates are suitable for this purpose. It is also possible to use mixtures of such di-, tri- or polyisocyanates. Examples of suitable di-, tri- or polyisocyanates are butylene diisocyanate, hexamethylene diisocyanate (HDI), isophorone diisocyanate (IPDI), 1,8-diisocyanato-4-(isocyanatomethyl)octane, 2,2,4- and/or 2,4,4-trimethylhexamethylene diisocyanate (TMDI), the isomeric bis(4,4′-isocyanatocyclohexyl)methanes and mixtures thereof having any desired isomer content, isocyanatomethyl-1,8-octane diisocyanate, 1,4-cyclohexylene diisocyanate, the isomeric cyclohexanedimethylene diisocyanates, 1,4-phenylene diisocyanate, 2,4- and/or 2,6-tolylene diisocyanate, 1,5-naphthylene diisocyanate, 2,4′- or 4,4′-diphenylmethane diisocyanate, triphenylmethane 4,4′,4″-triisocyanate or derivatives thereof having a urethane, urea, carbodiimide, acylurea, isocyanurate, allophanate, biuret, oxadiazinetrione, uretdione or iminooxadiazinedione structure and mixtures thereof. Polyisocyanates based on oligomerized and/or derivatized diisocyanates which were freed from excess diisocyanate by suitable processes are preferred, in particular those of hexamethylene diisocyanate. The oligomeric isocyanurates, uretdiones and iminooxadiazinediones of HDI and mixtures thereof are particularly preferred.

It is optionally also possible for the polyisocyanate component a) proportionately to contain isocyanates, which are partially reacted with isocyanate-reactive ethylenically unsaturated compounds. α,β-Unsaturated carboxylic acid derivatives, such as acrylates, methacrylates, maleates, fumarates, maleimides, acrylamides, and vinyl ethers, propenyl ethers, allyl ethers and compounds which contain dicyclopentadienyl units and have at least one group reactive towards isocyanates are preferably used here as isocyanate-reactive ethylenically unsaturated compounds; these are particularly preferably acrylates and methacrylates having at least one isocyanate-reactive group. Suitable hydroxy-functional acrylates or methacrylates are, for example, compounds such as 2-hydroxyethyl(meth)acrylate, polyethylene oxide mono(meth)acrylates, polypropylene oxide mono(meth)acrylates, polyalkylene oxide mono(meth)acrylates, poly(ε-caprolactone)mono(meth)acrylates, such as, for example, Tone® M100 (Dow, USA), 2-hydroxypropyl(meth)acrylate, 4-hydroxybutyl(meth)acrylate, 3-hydroxy-2,2-dimethylpropyl(meth)acrylate, the hydroxy-functional mono-, di- or tetra(meth)acrylates of polyhydric alcohols, such as trimethylolpropane, glycerol, pentaerythritol, dipentaerythritol, ethoxylated, propoxylated or alkoxylated trimethylolpropane, glycerol, pentaerythritol, dipentaerythritol and industrial mixtures thereof. In addition, isocyanate-reactive oligomeric or polymeric unsaturated compounds containing acrylate and/or methacrylate groups, alone or in combination with the abovementioned monomeric compounds, are suitable. The proportion of isocyanates which are partly reacted with isocyanate-reactive ethylenically unsaturated compounds, based on the isocyanate component a), is 0 to 99%, preferably 0 to 50%, particularly preferably 0 to 25% and very particularly preferably 0 to 15%.

It may also be possible for the abovementioned polyisocyanate component a) to contain, completely or proportionately, isocyanates which are reacted completely or partially with blocking agents known to the person skilled in the art from coating technology. The following may be mentioned as an example of blocking agents: alcohols, lactams, oximes, malonic esters, alkyl acetoacetates, triazoles, phenols, imidazoles, pyrazoles and amines, such as, for example, butanone oxime, diisopropylamine, 1,2,4-triazole, dimethyl-1,2,4-triazole, imidazole, diethyl malonate, ethyl acetoacetate, acetone oxime, 3,5-dimethylpyrazole, ε-caprolactam, N-tert-butylbenzylamine, cyclopentanone carboxyethyl ester or any desired mixtures of these blocking agents.

It is particularly preferable for the polyisocyanate component to be an aliphatic polyisocyanate or an aliphatic prepolymer and preferably an aliphatic polyisocyanate or a prepolymer with primary NCO groups.

All polyfunctional, isocyanate-reactive compounds which have on average at least 1.5 isocyanate-reactive groups per molecule can be used as isocyanate-reactive component b).

In the context of the present invention, isocyanate-reactive groups are preferably hydroxyl, amino or thio groups, and hydroxy compounds are particularly preferred. Suitable polyfunctional, isocyanate-reactive compounds are, for example, polyester-, polyether-, polycarbonate-, poly(meth)acrylate- and/or polyurethanepolyols.

Suitable polyesterpolyols are, for example, linear polyesterdiols or branched polyesterpolyols, as are obtained in a known manner from aliphatic, cycloaliphatic or aromatic di- or polycarboxylic acids or their anhydrides with polyhydric alcohols having an OH functionality of ≧2.

Examples of such di- or polycarboxylic acids or anhydrides are succinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic or trimellitic acid and acid anhydrides, such as o-phthalic, trimellitic or succinic anhydride or any desired mixtures thereof with one another.

Examples of suitable alcohols are ethanediol, di-, tri- or tetraethylene glycol, 1,2-propanediol, di-, tri- or tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol, trimethylolpropane, glycerol or any desired mixtures thereof with one another.

The polyesterpolyols may also be based on natural raw materials, such as castor oil. It is also possible for the polyesterpolyols to be based on homo- or copolymers of lactones, as can preferably be obtained by an addition reaction of lactones or lactone mixtures, such as butyrolactone, ε-caprolactone and/or methyl-ε-caprolactone, with hydroxy-functional compounds, such as polyhydric alcohols having an OH functionality of ≧2 for example of the aforementioned type.

Such polyesterpolyols preferably have number average molar masses of 400 to 4000 g/mol, particularly preferably of 500 to 2000 g/mol. Their OH functionality is preferably 1.5 to 3.5, particularly preferably 1.8 to 3.0.

Suitable polycarbonatepolyols are obtainable in a manner known per se by reacting organic carbonates or phosgene with diols or diol mixtures.

Suitable organic carbonates are dimethyl, diethyl and diphenyl carbonate.

Suitable diols or mixtures comprise the polyhydric alcohols mentioned in connection with the polyester segments and having an OH functionality of ≧2, preferably 1,4-butanediol, 1,6-hexanediol and/or 3-methylpentanediol, or polyesterpolyols can be converted into polycarbonatepolyols.

Such polycarbonatepolyols preferably have number average molar masses of 400 to 4000 g/mol, particularly preferably of 500 to 2000 g/mol. The OH functionality of these polyols is preferably 1.8 to 3.2, particularly preferably 1.9 to 3.0.

Suitable polyetherpolyols are polyadducts of cyclic ethers with OH- or NH-functional starter molecules, said polyadducts optionally having a block structure.

Suitable cyclic ethers are, for example, styrene oxides, ethylene oxide, propylene oxide, tetrahydrofuran, butylene oxide, epichlorohydrin and any desired mixtures thereof.

Starters which may be used are the polyhydric alcohols mentioned in connection with the polyesterpolyols and having an OH functionality of ≧2 and primary or secondary amines and amino alcohols.

Preferred polyetherpolyols are those of the abovementioned type, exclusively based on propylene oxide or random or block copolymers based on propylene oxide with further 1-alkylene oxides, the proportion of 1-alkylene oxides being not higher than 80 wt %. Propylene oxide homopolymers and random or block copolymers which have oxyethylene, oxypropylene and/or oxybutylene units are particularly preferred, the proportion of the oxypropylene units, based on the total amount of all oxyethylene, oxypropylene and oxybutylene units, accounting for at least 20 wt %, preferably at least 45 wt %. Here, oxypropylene and oxybutylene comprise all respective linear and branched C3- and C4-isomers.

Such polyetherpolyols preferably have number average molar masses of 250 to 10 000 g/mol, particularly preferably of 500 to 8500 g/mol and very particularly preferably of 600 to 4500 g/mol. The OH functionality is preferably 1.5 to 4.0, particularly preferably 1.8 to 3.1.

Special polyetherpolyols which are preferably used are those which consist of an isocyanate-reactive component comprising hydroxy-functional multiblock copolymers of the Y(Xᵢ—H)ₙ type with i=1 to 10 and n=2 to 8 and number average molecular weights greater than 1500 g/mol, the Xᵢ segments being composed in each case of oxyalkylene units of the formula I

—CH2—CH(R)—O— (I)

in which R is a hydrogen, alkyl or aryl radical which may also be substituted or may be interrupted by heteroatoms (such as ether oxygens), Y is a starter forming the basis, and the proportion of the Xᵢ segments, based on the total amount of the Xᵢ and Y segments, accounts for at least 50 wt %.

The outer blocks Xᵢ account for at least 50 wt %, preferably 66 wt %, of the total molar mass of Y(Xᵢ—H)ₙ and consist of monomer units which obey the formula I. In Y(Xᵢ—H)ₙ, n is preferably a number from 2 to 6, particularly preferably 2 or 3 and very particularly preferably 2. In Y(Xᵢ—H)ₙ, i is preferably a number from 1 to 6, particularly preferably from 1 to 3 and very particularly preferably 1.

In formula I, R is preferably a hydrogen, a methyl, butyl, hexyl or octyl group or an alkyl radical containing ether groups. Preferred alkyl radicals containing ether groups are those based on oxyalkylene units.

The multiblock copolymers Y(Xᵢ—H)ₙ preferably have number average molecular weights of more than 1200 g/mol, particularly preferably more than 1950 g/mol, but preferably not more than 12 000 g/mol, particularly preferably not more than 8000 g/mol.

The Xᵢ blocks may be homopolymers of exclusively identical oxyalkylene repeating units. They may also be composed randomly of different oxyalkylene units or in turn be composed of different oxyalkylene units in a block structure.

Preferably, the Xᵢ segments are based exclusively on propylene oxide or random or blockwise mixtures of propylene oxide with further 1-alkylene oxides, the proportion of further 1-alkylene oxides being not higher than 80 wt %.

Particularly preferred segments Xᵢ are propylene oxide homopolymers and random or block copolymers which contain oxyethylene and/or oxypropylene units, the proportion of the oxypropylene units, based on the total amount of all oxyethylene and oxypropylene units, accounting for at least 20 wt %, particularly preferably 40 wt %.

As described further below, the Xᵢ blocks are added to an n-fold hydroxy- or amino-functional starter block Y(H)ₙ by ring-opening polymerization of the alkylene oxides described above.

The inner block Y, which is present in an amount of less than 50 wt %, preferably less than 34 wt %, in Y(Xᵢ—H)ₙ, consists of dihydroxy-functional polymer structures and/or polymer structures having a higher hydroxy-functionality, based on cyclic ethers, or is composed of dihydroxy-functional polycarbonate, polyester, poly(meth)acrylate, epoxy resin and/or polyurethane structural units and/or said structural units having a higher hydroxy functionality or corresponding hybrids.

Suitable polyesterpolyols are linear polyesterdiols or branched polyesterpolyols, as can be prepared in a known manner from aliphatic, cycloaliphatic or aromatic di- or polycarboxylic acids or their anhydrides, such as, for example, succinic, glutaric, adipic, pimelic, suberic, azelaic, sebacic, nonanedicarboxylic, decanedicarboxylic, terephthalic, isophthalic, o-phthalic, tetrahydrophthalic, hexahydrophthalic or trimellitic acid and acid anhydrides, such as o-phthalic, trimellitic or succinic anhydride, or any desired mixtures thereof with polyhydric alcohols, such as, for example, ethanediol, di-, tri- or tetraethylene glycol, 1,2-propanediol, di-, tri- or tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol or mixtures thereof, optionally with concomitant use of polyols having a higher functionality, such as trimethylolpropane or glycerol. Suitable polyhydric alcohols for the preparation of the polyesterpolyols are of course also cycloaliphatic and/or aromatic di- and polyhydroxy compounds. Instead of the free polycarboxylic acid, it is also possible to use the corresponding polycarboxylic anhydrides or corresponding polycarboxylic esters of lower alcohols or mixtures thereof for the preparation of the polyesters.

The polyesterpolyols may also be based on natural raw materials, such as castor oil. It is also possible for the polyesterpolyols to be based on homo- or copolymers of lactones, as can preferably be obtained by an addition reaction of lactones or lactone mixtures such as butyrolactone, ε-caprolactone and/or methyl-c-caprolactone, with hydroxy-functional compounds, such as polyhydric alcohols having an OH functionality of preferably 2, for example of the abovementioned type.

Such polyesterpolyols preferably have number average molar masses of 200 to 2000 g/mol, particularly preferably of 400 to 1400 g/mol.

Suitable polycarbonatepolyols are obtainable in a manner known per se by reacting organic carbonates or phosgene with diols or diol mixtures.

Suitable organic carbonates are dimethyl, diethyl and diphenyl carbonate.

Suitable diols or mixtures comprise the polyhydric alcohols mentioned per se in connection with the polyesterpolyols and having an OH functionality of 2, preferably 1,4-butanediol, 1,6-hexanediol and/or 3-methylpentanediol. Polyesterpolyols may also be converted into polycarbonatepolyols. Dimethyl or diethyl carbonate is particularly preferably used in the reaction of said alcohols to give polycarbonatepolyols.

Such polycarbonatepolyols preferably have number average molar masses of 400 to 2000 g/mol, particularly preferably of 500 to 1400 g/mol and very particularly preferably of 650 to 1000 g/mol.

Suitable polyetherpolyols are polyadducts of cyclic ethers with OH- or NH-functional starter molecules, which polyadducts optionally have a block structure. For example, the polyadducts of styrene oxides, of ethylene oxide, propylene oxide, tetrahydrofuran, butylene oxide, epichlorohydrin, and their mixed adducts and graft products, and the polyetherpolyols obtained by condensation of polyhydric alcohols or mixtures thereof and the polyetherpolyols obtained by alkoxylation of polyhydric alcohols, amines and amino alcohols, may be mentioned as polyetherpolyols.

Suitable polymers of cyclic ethers are in particular polymers of tetrahydrofuran.

The polyhydric alcohols mentioned per se in connection with the polyesterpolyols, and primary or secondary amines and amino alcohols having an OH or NH functionality of 2 to 8, preferably 2 to 6, particularly preferably 2 to 3, very particularly preferably 2, may be used as starters.

Such polyetherpolyols preferably have number average molar masses of 200 to 2000 g/mol, particularly preferably of 400 to 1400 g/mol and very particularly preferably of 650 to 1000 g/mol.

The polymers of tetrahydrofuran are preferably employed as polyetherpolyols used for starters.

Of course, mixtures of the components described above can also be used for the inner block Y.

Preferred components for the inner block Y are polymers of tetrahydrofuran and aliphatic polycarbonatepolyols and polyesterpolyols and polymers of ε-caprolactone having number average molar masses of less than 3100 g/mol.

Particularly preferred components for the inner block Y are difunctional polymers of tetrahydrofuran and difunctional aliphatic polycarbonatepolyols and polyesterpolyols and polymers of ε-caprolactone having number average molar masses of less than 3100 g/mol.

Very particularly preferably, the starter segment Y is based on difunctional, aliphatic polycarbonatepolyols, poly(ε-caprolactone) or polymers of tetrahydrofuran having number average molar masses greater than 500 g/mol and less than 2100 g/mol.

Preferably used block copolymers of the structure Y(Xᵢ—H)ₙ comprise more than 50 percent by weight of the Xᵢ blocks described above and have a number average total molar mass of greater than 1200 g/mol.

Particularly preferred block copolyols consist of less than 50 percent by weight of aliphatic polyester, aliphatic polycarbonatepolyol or poly-THF and more than 50 percent by weight of the blocks Xᵢ described above as being according to the invention and have a number average molar mass of greater than 1200 g/mol. Particularly preferred block copolymers consist of less than 50 percent by weight of aliphatic polycarbonatepolyol, poly(e-caprolactone) or poly-THF and more than 50 percent by weight of the blocks Xᵢ described above as being according to the invention and have a number average molar mass of greater than 1200 g/mol.

Very particularly preferred block copolymers consist of less than 34 percent by weight of aliphatic polycarbonatepolyol, poly(s-caprolactone) or poly-THF and more than 66 percent by weight of the blocks Xᵢ described above as being according to the invention and have a number average molar mass of greater than 1950 g/mol and less than 9000 g/mol.

The block copolyols described are prepared by alkylene oxide addition processes.

Writing monomer B) utilizes one or more different compounds which are themselves free of NCO groups and have groups (radiation-curable groups) which under the action of actinic radiation react with ethylenically unsaturated compounds by polymerization. The writing monomers are preferably acrylates and/or methacrylates. Urethane acrylates and urethane(meth)acrylates are very particularly preferable.

In a further preferred embodiment, the writing monomer B) comprises at least a mono- and/or a multifunctional writing monomer, more particularly comprises mono- and multifunctional acrylate writing monomers. It is particularly preferable for the writing monomer to comprise at least a monofunctional and a multifunctional urethane(meth)acrylate.

Acrylate writing monomers may be more particularly compounds of general formula (II)

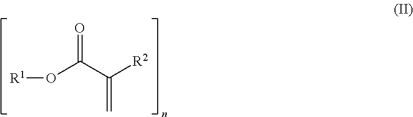

where in each case n is ≧1 and n≦4 and R¹, R² are independently of each other hydrogen, linear, branched, cyclic or heterocyclic unsubstituted or else optionally heteroatom-substituted organic radicals. It is particularly preferable for R² to be hydrogen or methyl and/or R¹ to be a linear, branched, cyclic or heterocyclic unsubstituted or else optionally heteroatom-substituted organic radical.

It is similarly possible to add further unsaturated compounds such as α,β-unsaturated carboxylic acid derivatives such as acrylates, methacrylates, maleates, fumarates, maleimides, acrylamides, also vinyl ether, propenyl ether, allyl ether and dicyclopentadienyl-containing compounds and also olefinically unsaturated compounds such as, for example, styrene, α-methylstyrene, vinyltoluene, olefins, for example 1-octene and/or 1-decene, vinyl esters, (meth)acrylonitrile, (meth)acrylamide, methacrylic acid, acrylic acid. Preference, however, is given to acrylates and methacrylates.

In general, esters of acrylic acid and methacrylic acid are designated as acrylates and methacrylates, respectively. Examples of acrylates and methacrylates which can be used are methyl acrylate, methyl methacrylate, ethyl acrylate, ethyl methacrylate, ethoxyethyl acrylate, ethoxyethyl methacrylate, n-butyl acrylate, n-butyl methacrylate, tert-butyl acrylate, tert-butyl methacrylate, hexyl acrylate, hexyl methacrylate, 2-ethylhexyl acrylate, 2-ethylhexyl methacrylate, butoxyethyl acrylate, butoxyethyl methacrylate, lauryl acrylate, lauryl methacrylate, isobornyl acrylate, isobornyl methacrylate, phenyl acrylate, phenyl methacrylate, p-chlorophenyl acrylate, p-chlorophenyl methacrylate, p-bromophenyl acrylate, p-bromophenyl methacrylate, 2,4,6-trichlorophenyl acrylate, 2,4,6-trichlorophenyl methacrylate, 2,4,6-tribromophenyl acrylate, 2,4,6-tribromophenyl methacrylate, pentachlorophenyl acrylate, pentachlorophenyl methacrylate, pentabromophenyl acrylate, pentabromophenyl methacrylate, pentabromobenzyl acrylate, pentabromobenzyl methacrylate, phenoxyethyl acrylate, phenoxyethyl methacrylate, phenoxyethoxyethyl acrylate, phenoxyethoxyethyl methacrylate, phenylthioethyl acrylate, phenylthioethyl methacrylate, 2-naphthyl acrylate, 2-naphthyl methacrylate, 1,4-bis(2-thionaphthyl)-2-butyl acrylate, 1,4-bis(2-thionaphthyl)-2-butyl methacrylate, propane-2,2-diylbis[(2,6-dibromo-4,1-phenylene)oxy(2-{[3,3,3-tris(4-chlorophenyl)propanoyl]oxy}propane-3,1-diyl)oxyethane-2,1-diyl]diacrylate, bisphenol A diacrylate, bisphenol A dimethacrylate, tetrabromobisphenol A diacrylate, tetrabromobisphenol A dimethacrylate and the ethoxylated analogue compounds thereof, N-carbazolyl acrylates, to mention only a selection of acrylates and methacrylates which may be used.

Urethane acrylates are understood as meaning compounds having at least one acrylic acid ester group which additionally have at least one urethane bond. It is known that such compounds can be obtained by reacting a hydroxy-functional acrylic acid ester with an isocyanate-functional compound.

Examples of isocyanate-functional compounds which can be used for this purpose are aromatic, araliphatic, aliphatic and cycloaliphatic di-, tri- or polyisocyanates. It is also possible to use mixtures of such di-, tri- or polyisocyanates. Examples of suitable di-, tri- or polyisocyanates are butylene diisocyanate, hexamethylene diisocyanate (HDI), isophorone diisocyanate (IPDI), 1,8-diisocyanato-4-(isocyanatomethyl)octane, 2,2,4- and/or 2,4,4-trimethylhexamethylene diisocyanate, the isomeric bis(4,4′-isocyanatocyclohexyl)methanes and mixtures thereof having any desired isomer content, isocyanatomethyl-1,8-octane diisocyanate, 1,4-cyclohexylene diisocyanate, the isomeric cyclohexanedimethylene diisocyanates, 1,4-phenylene diisocyanate, 2,4- and/or 2,6-tolylene diisocyanate, 1,5-naphthylene diisocyanate, 2,4′- or 4,4′-diphenylmethane diisocyanate, 1,5-naphthylene diisocyanate, m-methylthiophenyl isocyanate, triphenylmethane 4,4′,4″-triisocyanate and tris(p-isocyanatophenyl)thiophosphate or derivatives thereof having a urethane, urea, carbodiimide, acylurea, isocyanurate, allophanate, biuret, oxadiazinetrione, uretdione or iminooxadiazinedione structure and mixtures thereof. Aromatic or araliphatic di-, tri- or polyisocyanates are preferred.

Suitable hydroxy-functional acrylates or methacrylates for the preparation of urethane acrylates are compounds such as 2-hydroxyethyl(meth)acrylate, polyethylene oxide mono(meth)acrylates, polypropylene oxide mono(meth)acrylates, polyalkylene oxide mono(meth)acrylates, poly(s-caprolactone)mono(meth)acrylates, such as, for example, Tone® M100 (Dow, Schwalbach, Germany), 2-hydroxypropyl(meth)acrylate, 4-hydroxybutyl(meth)acrylate, 3-hydroxy-2,2-dimethylpropyl(meth)acrylate, hydroxypropyl(meth)acrylate, 2-hydroxy-3-phenoxypropyl acrylate, the hydroxyfunctional mono-, di- or tetraacrylates of polyhydric alcohols, such as trimethylolpropane, glycerol, pentaerythritol, dipentaerythritol, ethoxylated, propoxylated or alkoxylated trimethylolpropane, glycerol, pentaerythritol, dipentaerythritol or industrial mixtures thereof. 2-Hydroxyethyl acrylate, hydroxypropyl acrylate, 4-hydroxybutyl acrylate and poly(ε-caprolactone)mono(meth)acrylates are preferred. In addition, isocyanate-reactive oligomeric or polymeric unsaturated compounds containing acrylate and/or methacrylate groups, alone or in combination with the abovementioned monomeric compounds, are suitable. The epoxy(meth)acrylates known per se containing hydroxyl groups and having OH contents of 20 to 300 mg KOH/g or polyurethane(meth)acrylates containing hydroxyl groups and having OH contents of 20 to 300 mg KOH/g or acrylated polyacrylates having OH contents of 20 to 300 mg KOH/g and mixtures thereof with one another and mixtures with unsaturated polyesters containing hydroxyl groups and mixtures with polyester(meth)acrylates or mixtures of unsaturated polyesters containing hydroxyl groups with polyester (meth)acrylates can likewise be used.

Preference is given particularly to urethane acrylates obtainable from the reaction of tris(p-isocyanatophenyl)thiophosphate and m-methylthiophenyl isocyanate with alcohol-functional acrylates such as hydroxyethyl(meth)acrylate, hydroxypropyl(meth)acrylate and hydroxybutyl(meth)acrylate.

The employed photoinitiators C) are typically compounds which are activatable by actinic radiation and capable of inducing a polymerization of corresponding groups.

Photoinitiators can be distinguished into unimolecular initiators (type I) and bimolecular initiators (type II). They are further distinguished according to their chemical character into photoinitiators for free-radical, anionic, cationic or mixed type of polymerization.

Type I photoinitiators (Norrish type I) for free-radical photopolymerization form free radicals on irradiation by unimolecular bond cleavage.

Examples of type I photoinitiators are triazines, for example tris(trichloromethyl)triazine, oximes, benzoin ethers, benzil ketals, alpha-alpha-dialkoxyacetophenone, phenylglyoxylic esters, bisimidazoles, aroylphosphine oxides, e.g. 2,4,6-trimethylbenzoyldiphenylphosphine oxide, sulphonium and iodonium salts.

Type II photoinitiators (Norrish type II) for free-radical polymerization undergo a bimolecular reaction on irradiation wherein the photoinitiator reacts in the excited state with a second molecule, the coinitiator, and forms the polymerization-inducing free-radicals by electron or proton transfer or direct hydrogen abstraction.

Examples of type II photoinitiators are quinones, for example camphorquinone, aromatic keto compounds, for example benzophenones combined with tertiary amines, alkylbenzophenones, halogenated benzophenones, 4,4′-bis(dimethylamino)benzophenone (Michler's ketone), anthrone, methyl p-(dimethylamino)benzoate, thioxantho^{ne}, ketocoumarins, alpha-aminoalkylphenone, alpha-hydroxyalkylphenone and cationic dyes, for example methylene blue, combined with tertiary amines.

Type I and type II photoinitiators are used for the UV and short-wave visible region, while predominantly type II photoiniators are used for the comparatively long-wave visible spectrum.

The photoinitiator systems described in EP 0 223 587 A, consisting of a mixture of an ammonium alkyl arylborate and one or more dyes are also useful as type II photoinitiator for free-radical polymerization. Examples of suitable ammonium alkyl arylborates are tetrabutylammonium triphenylhexylborate, tetrabutylammonium triphenylbutylborate, tetrabutylammonium trinaphthylhexylborate, tetrabutylammonium tris(4-tert-butyl)phenylbutylborate, tetrabutylammonium tris(3-fluorophenyl)hexylborate, tetramethylammonium triphenylbenzylborate, tetra(n-hexyl)ammonium (sec-butyl)triphenylborate, 1-methyl-3-octylimidazolium dipentyldiphenylborate and tetrabutylammonium tris(3-chloro-4-methylphenyl)hexylborate (Cunningham et al., RadTech'98 North America UV/EB Conference Proceedings, Chicago, Apr. 19-22, 1998).

The photoinitiators used for anionic polymerization are generally type I systems and derive from transition metal complexes of the first row. Examples which may be mentioned here are chromium salts, for example trans-Cr(NH₃)₂(NCS)₄⁻ (Kutal et al, Macromolecules 1991, 24, 6872) or ferrocenyl compounds (Yamaguchi et al. Macromolecules 2000, 33, 1152).

A further option for anionic polymerization is to use dyes, such as crystal violet leuconitrile or malachite green leuconitrile, which are capable of polymerizing cyanoacrylates through photolytic decomposition (Neckers et al. Macromolecules 2000, 33, 7761). The chromophore becomes incorporated in the resulting polymers, making these intrinsically coloured.

Photoinitiators useful for cationic polymerization consist essentially of three classes: aryldiazonium salts, onium salts (here specifically: iodonium, sulphonium and selenonium salts) and also organometallic compounds. Phenyldiazonium salts are capable on irradiation of producing, not only in the presence but also in the absence of a hydrogen donor, a cation which initiates the polymerization. The efficiency of the overall system is determined by the nature of the counterion used to the diazonium compound. Preference is given to the little-reactive but fairly costly SbF₆⁻, AsF₆⁻ or PF₆⁻. These compounds are generally less suitable for use in coating thin films, since the nitrogen released following exposure reduces surface quality (pinholes) (Li et al., Polymeric Materials Science and Engineering, 2001, 84, 139).

Onium salts, specifically sulphonium and iodonium salts, are very widely used and also commercially available in a wide variety of forms. The photochemistry of these compounds has been the subject of sustained investigation. Iodonium salts on excitation initially disintegrate homolytically and thereby produce one free radical and one free-radical cation which transitions by hydrogen abstraction into a cation which finally releases a proton and thereby initiates cationic polymerization (Dektar et al. J. Org. Chem. 1990, 55, 639; J. Org. Chem., 1991, 56. 1838). This mechanism makes it possible for iodonium salts to likewise be used for free-radical photopolymerization. The choice of counterion is again very important here. Preference is likewise given to using SbF₆⁻, AsF₆⁻ or PF₆⁻. This structural class is in other respects fairly free as regards the choice of substitution on the aromatic, being essentially determined by the availability of suitable synthons. Sulphonium salts are compounds that decompose by the Norrish type II mechanism (Crivello et al., Macromolecules, 2000, 33, 825). The choice of counterion is also critically important in sulphonium salts because it is substantially reflected in the curing rate of the polymers. The best results are generally achieved in SbF₆⁻ salts.

Since the intrinsic absorption of iodonium and sulphonium salts is <300 nm, these compounds should be appropriately sensitized for a photopolymerization with near UV or short-wave visible light. This is accomplished by using aromatics that absorb at longer wavelengths, for example anthracene and derivatives (Gu et al., Am. Chem. Soc. Polymer Preprints, 2000, 41 (2), 1266) or phenothiazine and/or derivatives thereof (Hua et al, Macromolecules 2001, 34, 2488-2494).

It can be advantageous to use mixtures of these sensitizers or else photoinitiators. Depending on the radiation source used, photoinitiator type and concentration has to be adapted in a manner known to a person skilled in the art. Further particulars are described for example in P. K. T. Oldring (Ed.), Chemistry & Technology of UV & EB Formulations For Coatings, Inks & Paints, Vol. 3, 1991, SITA Technology, London, pp. 61-328.

Preferred photoinitiators are mixtures of tetrabutylammonium tetrahexylborate, tetrabutylammonium triphenylhexylborate, tetrabutylammonium triphenylbutylborate, tetrabutylammonium tris(3-fluorophenyl)hexylborate ([191726-69-9], CGI 7460, product from BASF SE, Basle, Switzerland) and tetrabutylammonium tris(3-chloro-4-methylphenyl)hexylborate ([1147315-11-4], CGI 909, product from BASF SE, Basle, Switzerland) with cationic dyes as described for example in H. Berneth in Ullmann's Encyclopedia of Industrial Chemistry, Cationic Dyes, Wiley-VCH Verlag, 2008.

Examples of cationic dyes are Astrazon Orange G, Basic Blue 3, Basic Orange 22, Basic Red 13, Basic Violet 7, methylene blue, New Methylene Blue, Azure A, Pyrillium I, Safranin O, cyanine, gallocyanine, brilliant green, crystal violet, ethyl violet and thionine.

It is particularly preferable for the photopolymer formulation of the present invention to contain a cationic dye of formula F⁺An⁻.

Cationic dyes of formula F⁺are preferably cationic dyes of the following classes: acridine dyes, xanthene dyes, thioxanthene dyes, phenazine dyes, phenoxazine dyes, phenothiazine dyes, tri(het)arylmethane dyes—especially diamino- and triamino(het)arylmethane dyes, mono-, di- and trimethinecyanine dyes, hemicyanine dyes, externally cationic merocyanine dyes, externally cationic neutrocyanine dyes, nullmethine dyes—especially naphtholactam dyes, streptocyanine dyes. Such dyes are described for example in H. Berneth in Ullmann's Encyclopedia of Industrial Chemistry, Azine Dyes, Wiley-VCH Verlag, 2008, H. Berneth in Ullmann's Encyclopedia of Industrial Chemistry, Methine Dyes and Pigments, Wiley-VCH Verlag, 2008, T. Gessner, U. Mayer in Ullmann's Encyclopedia of Industrial Chemistry, Triarylmethane and Diarylmethane Dyes, Wiley-VCH Verlag, 2000.

An is to be understood as referring to an anion. Preferred anions An⁻ are especially C₈- to C₂₅-alkansulphonate, preferably C₁₃- to C₂₅-alkanesulphonate, C₃- to C₁₈-perfluoroalkane-sulphonate, C₄- to C₁₈-perfluoroalkanesulphonate bearing at least 3 hydrogen atoms in the alkyl chain, C₉- to C₂₅-alkanoate, C₉- to C₂₅-alkenoate, C₈- to C₂₅-alkyl sulphate, preferably C₁₃- to C₂₅-alkyl sulphate, C₈- to C₂₅-alkenyl sulphate, preferably C₁₃- to C₂₅-alkenyl sulphate, C₃- to C₁₈-perfluoroalkyl sulphate, C₄- to C₁₈-perfluoroalkyl sulphate bearing at least 3 hydrogen atoms in the alkyl chain, polyether sulphates based on at least 4 equivalents of ethylene oxide and/or equivalents 4 of propylene oxide, bis-C₄- to C₂₅-alkyl sulphosuccinate, bis-C₅- to C₇-cycloalkyl sulphosuccinate, bis-C₃- to C₈-alkenyl sulphosuccinate, bis-C₇- to C₁₁-aralkyl sulphosuccinate, a bis-C₂- to C₁₀-alkyl sulphosuccinate substituted by at least 8 fluorine atoms, C₈- to C₂₅-alkyl sulphoacetates, benzenesulphonate substituted by at least one moiety from the group halogen, C₄- to C₂₅-alkyl, perfluoro-C₁- to C₈-alkyl and/or C₁- to C₁₂-alkoxycarbonyl, optionally nitro-, cyano-, hydroxyl-, C₁- to C₂₅-alkyl-, C₁- to C₁₂-alkoxy-, amino-, C₁- to C₁₂-alkoxycarbonyl- or chlorine-substituted naphthalene- or biphenylsulphonate, optionally nitro-, cyano-, hydroxyl-, C₁- to C₂₅-alkyl-, C₁- to C₁₂-alkoxy-, C₁- to C₁₂-alkoxycarbonyl- or chlorine-substituted benzene-, naphthalene- or biphenyldisulphonate, dinitro-, C₆- to C₂₅-alkyl-, C₄- to C₁₂-alkoxycarbonyl-, benzoyl-, chlorobenzoyl- or toluoyl-substituted benzoate, the anion of naphthalenedicarboxylic acid, diphenyl ether disulphonate, sulphonated or sulphated, optionally mono- or polyunsaturated C₈- to C₂₅-fatty acid esters of aliphatic C₁- to C₈-alcohols or glycerol, bis(sulpho-C₂- to C₆-alkyl) C₃ to C₁₂ alkanedicarboxylic acid esters, bis(sulpho-C₂ to C₆-alkyl) itaconic acid esters, C₃- to C₁₂-alkanedicarboxylic acid esters, bis(sulpho-C₂- to C₆₋alkyl) itaconic acid esters, (sulpho-C₂- to C₆-alkyl) C₆- to C₁₈-alkanecarboxylic acid esters, (sulpho-C₂- to C₆-alkyl)acrylic or methacrylic acid esters, tricatechol phosphate optionally substituted by up to 12 halogen moieties, an anion from the group tetraphenylborate, cyanotriphenylborate, tetraphenoxyborate, C₄- to C₁₂-alkyltriphenylborate whose phenyl or phenoxy moieties may be halogen, C₁- to C₄-alkyl and/or C₁- to C₄-alkoxy substituted, C₄- to C₁₂-alkyltrinaphthylborate, tetra-C₁- to C₂₀-alkoxyborate, 7,8- or 7,9-dicarbanidoundecaborate(1-) or (2-), which are optionally substituted by one or two C₁- to C₁₂-alkyl or phenyl groups on the B and/or C atoms, dodecahydrodicarbadodecaborate(2-) or B—C₁- to C₁₂-alkyl-C-phenyl-dodecahydrodicarbadodecaborat(1-), where An in multivalent anions such as naphthalenedisulphonate represents one equivalent of this anion, and where the alkane and alkyl groups may be branched and/or may be halogen, cyano, methoxy, ethoxy, methoxycarbonyl or ethoxycarbonyl substituted.

Particularly preferred anions are sec-C₁₁- to C₁₈-alkanesulphonate, C₁₃- to C₂₅-alkyl sulphate, branched C₈- to C₂₅-alkyl sulphate, optionally branched bis-C₆- to C₂₅-alkyl sulphosuccinate, sec- or tert-C₄- to C₂₅-alkylbenzenesulphonate, sulphonated or sulphated, optionally monounsaturated or polyunsaturated C₈- to C₂₅-fatty acid esters of aliphatic C₁- to C₈-alcohols or glycerol, bis(sulpho-C₂- to C₆-alkyl) C₃- to C₁₂-alkanedicarboxylic acid esters, (sulpho-C₂- to C₆-alkyl) C₆- to C₁₈-alkanecarboxylic acid esters, triscatechol phosphate substituted by up to 12 halogen moieties, cyanotriphenylborate, tetraphenoxyborate, butyltriphenylborate.

It is also preferable for the anion An⁻ of the dye to have an AClogP in the range of 1-30, more preferably in the range of 1-12 and even more preferably in the range of 1-6.5. The AClogP is computed as described in J. Comput. Aid. Mol. Des. 2005, 19, 453; Virtual Computational Chemistry Laboratory, http://www.vcclab.org.

Particular preference is given to dyes F⁺An⁻ having a water imbibition 55 wt %.

Water Imbibition is Given by Formula (F-1)

W=(m_{f}/mₜ−1)*100% (F-1),

where m_{f} is the mass of the dye after water saturation and mₜ is the mass of the dried dye. mₜ is ascertained by drying a particular quantity of dye to constant mass at elevated temperature in vacuo for example. m_{f} is determined by letting a particular quantity of dye stand in air at a defined humidity to constant weight.

It is very particularly preferable for the photoinitiator to comprise a combination of dyes, the absorption spectra of which cover the spectral region from 400 to 800 nm partly at least, with at least a coinitiator tuned to the dyes.

The catalyst D) may comprise at least a compound of general formula (III) or (IV)

R³Sn(IV)L₃ (III)

L₂Sn(IV)R³₂ (IV)

where

R³ is a linear or branched alkyl moiety of 1-30 carbon atoms which is optionally substituted with heteroatoms, especially with oxygen, even in the chain and

L independently in each occurrence represents ⁻O₂C—R⁴ groups in each of which R⁴ is a linear or branched alkyl moiety of 1-30 carbon atoms optionally substituted with heteroatoms, especially with oxygen, even in the chain, an alkenyl moiety of 2-30 carbon atoms or any desired substituted or unsubstituted optionally polycyclic aromatic ring with or without heteroatoms.

It is particularly preferable here for R³ to be a linear or branched alkyl moiety of 1-12 carbon atoms, more preferably methyl, ethyl, propyl, n-, i-, t-butyl, n-octyl and most preferably n-, i-, t-butyl, and/or for R⁴ is a linear or branched alkyl moiety of 1-17 carbon atoms optionally substituted with heteroatoms, especially with oxygen, even in the chain, or an alkenyl moiety of 2-17 carbon atoms, more preferably a linear or branched alkyl or alkenyl moiety having 3-13 carbon atoms and most preferably a linear or branched alkyl or alkenyl moiety having 5-11 carbon atoms. More particularly, L is the same in each occurrence.

Further suitable catalysts are for example compounds of general formula (V) or (VI).

Bi(III)M₃ (V),

Sn(II)M₂ (VI),

where M in each occurrence is independently an ⁻O₂C—R⁵ group where R⁵ is saturated or unsaturated C₁- to C₁₉-alkyl or C₂- to C₁₉-alkenyl moiety which is saturated or unsaturated or substituted with heteroatoms, especially C₆- to C₁₁-alkyl moiety and more preferably a C₇- to C₉-alkyl moiety or a C₁- to C₁₈-alkyl moiety which is optionally substituted aromatically or with oxygen or nitrogen in any desired form, and M need not be the same in formula (V) and (VI).

It is particularly preferable for the urethanization catalyst D) to be selected from the group of abovementioned compounds of formula (III) and/or (IV).

In a further preferred embodiment, the photopolymer formulation additionally contains additives F) and more preferably urethanes as additives, which urethanes may be more particularly substituted with at least a fluorine atom.

The additives may preferably have the general formula (VII)

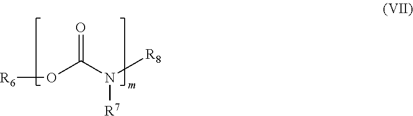

where m is ≧1 and m is ≦8 and R⁶, R⁷, R⁸ are each independently hydrogen, linear, branched, cyclic or heterocyclic moieties which are unsubstituted or optionally substituted even with heteroatoms, wherein preferably at least one of R⁶, R⁷, R⁸ is substituted with at least a fluorine atom and more preferably R⁶ is an organic moiety having at least one fluorine atom. It is particularly preferable for R⁶ to be a linear, branched, cyclic or heterocyclic organic moiety which is unsubstituted or optionally substituted even with heteratoms such as fluorine for example.

The invention also provides a holographic medium containing a photopolymer formulation of the present invention or obtainable by using a photopolymer formulation of the present invention.

A preferred embodiment of the holographic medium according to the present invention may comprise a film of the photopolymer formulation. In this case, it may additionally comprise a covering layer and/or a carrier layer which are optionally each connected at least regionally to the film.

The holographic medium of the present invention may also have a hologram exposed into it using customary methods.

The invention yet further provides for the use of a photopolymer formulation of the present invention for producing holographic media.

The invention also provides a process for producing a holographic medium, wherein
(I) a photopolymer formulation according to the present invention is produced by mixing all constituents,
(II) the photopolymer formulation is introduced at a processing temperature into the form desired for the holographic medium and
(III) is cured in the desired form at a crosslinking temperature above the processing temperature with urethane formation,
   wherein it is possible for the processing temperature to be more particularly ≧15 and ≦40° C. and preferably ≧18 and ≦25° C. and for the crosslinking temperature to be ≧60° C. and ≦100° C., preferably ≧70° C. and ≦95° C. and more preferably ≧75° C. and ≦90° C.

It is preferable for the photopolymer formulation to be brought into the form of a film in step II). For this, the photopolymer formulation can be applied flat to a carrier substrate for example, in which case the devices known to a person skilled in the art such as blade devices (doctor blade, knife-over-roll, commabar, etc) or a slot die can be used for example.

The carrier substrate used may preferably be a layer of a material, or of an ensemble of materials, which is transparent to light in the visible spectrum (transmission greater than 85% in the wavelength range from 400 to 780 nm). However, other even non-transparent carrier substrates can likewise be used.

Preferred materials or ensembles of materials for the carrier substrate are based on polycarbonate (PC), polyethylene terephthalate (PET), polybutylene terephthalate, polyethylene, polypropylene, cellulose acetate, cellulose hydrate, cellulose nitrate, cycloolefin polymers, polystyrene, polyepoxides, polysulphone, cellulose triacetate (CTA), polyamide, polymethyl methacrylate, polyvinyl chloride, polyvinyl butyral or polydicyclopentadiene or mixtures thereof. They are more preferably based on PC, PET and CTA. Ensembles of materials can be foil laminates or coextrudates. Preferred ensembles of materials are duplex and triplex foils constructed according to one of the schemes A/B, A/B/A or A/B/C. Particular preference is given to PC/PET, PET/PC/PET and PC/TPU (TPU=thermoplastic polyurethane).

As an alternative to the aforementioned carrier substrates, planar glass plates can also be used, especially for large-area accurately imaging exposures, for example for holographic lithography (Holografic interference lithography for integrated optics. IEEE Transactions on Electron Devices (1978), ED-25 (10), 1193-1200, ISSN:0018-9383).

The materials or ensembles of materials for the carrier substrate may have an anti-stick, antistatic, hydrophobic or hydrophilic finish on one or both sides. On the side facing the photopolymer, the modifications mentioned serve the purpose of making it possible to remove the photopolymer from the carrier substrate non-destructively. A modification of that side of the carrier substrate which faces away from the photopolymer serves to ensure that the media of the present invention meet specific mechanical requirements, for example in relation to processing in roll laminators, more particularly in roll-to-roll processes.

The carrier substrate may have a coating on one or both sides.

The invention also provides a holographic medium obtainable by the process of the present invention.

The invention yet further provides a layered construction comprising a carrier substrate, a film thereon of a photopolymer formulation according to the present invention and optionally also a covering layer on that side of the film which is remote from the carrier substrate.

The layered construction can more particularly include one or more covering layers on the film in order that the film may be protected from dirt and environmental effects. Polymeric foils or foil laminate systems can be used for this, but also clearcoat lacquers.

The covering layers are preferably foil materials that are similar to the materials used in the carrier substrate, the thickness of which is typically in the range from 5 to 200 μm, preferably in the range from 8 to 125 μm and more preferably in the range from 20 to 50 μm.

Preference is given to covering layers having a very smooth surface. The determinative measure here is the roughness determined to DIN EN ISO 4288 “Geometrical Product Specifications (GPS)—Surface texture”, test condition R3z front and back. Preferred roughnesses are in the range of not more than 2 μm, preferably not more than 0.5 μm.

The covering layers used are preferably PE or PET foils from 20 to 60 μm in thickness. It is particularly preferable to use a polyethylene foil 40 μm in thickness.

It is likewise possible for a layered construction to include a further covering layer on the carrier substrate as protective layer.

The invention likewise provides for use of a holographic medium according to the present invention for producing a hologram, especially an in-line, off-axis, full-aperture transfer, white light transmissions, Denisyuk, off-axis reflection or edge-lit hologram and also a holographic stereogram.

The holographic media of the present invention can be processed into holograms through appropriate exposure operations for optical applications in the entire visible and near UV range (300-800 nm). Visual holograms include all holograms recordable by processes known to a person skilled in the art. These include inter alia in-line (Gabor) holograms, off-axis holograms, full-aperture transfer holograms, white light transmission holograms (“rainbow holograms”), Denisyuk holograms, off-axis reflection holograms, edge-lit holograms and also holographic stereograms. Preference is given to reflection holograms, Denisyuk holograms, transmission holograms.

Possible optical functions of holograms obtainable using the media of the present invention may correspond to the optical functions of optical elements such as lenses, mirrors, deflectors, filters, scattering disks, diffraction elements, optical fibers, waveguides, projection disks and/or masks. These optical elements frequently exhibit a frequency selectivity according to how the holograms were exposed and what the dimensions of the hologram are.

In addition, the holographic media of the present invention can also be used to produce holographic images or representations, for example for personal portraits, biometric representations in security documents, or generally images or image structures for advertising, security tags, brand protection, branding, labels, design elements, decorations, illustrations, collectable cards, images and the like and also images capable of representing digital data, inter alia in combination with the aforementioned products. Holographic images can have the impression of a three-dimensional image, but they can also show image sequences, short films or a number of different objects, depending on the angle from which they are illuminated, the light source with which they are illuminated (including moving ones), etc. Owing to these various possible designs, holograms, especially volume holograms, are an attractive technical solution for the abovementioned application.

The invention will now be more particularly elucidated using examples.

### EXAMPLES

### Materials Used

Isocyanate component 1 is a commercial product (Desmodur® N 3900) from Bayer MaterialScience AG, Leverkusen, Germany, a polyisocyanate based on hexane diisocyanate, at least 30% proportion of iminooxadiazinedione, NCO content: 23.5%.

Isocyanate component 2 is a trial product (Desmodur® E VP XP 2747) from Bayer MaterialScience AG, Leverkusen, Germany, high-NCO-containing aliphatic prepolymer based on hexane diisocyanate, NCO content: about 17%.

Polyols 1-3 are experimental products from Bayer MaterialScience AG, Leverkusen, Germany, their methods of making are described hereinbelow.

Writing monomer 1 is an experimental product from Bayer MaterialScience AG, Leverkusen, Germany, prepared as described hereinbelow. Writing monomer 2 is an experimental product from Bayer MaterialScience AG, Leverkusen, Germany, prepared as described hereinbelow.

Additive 1 is an experimental product from Bayer MaterialScience AG, Leverkusen, Germany, prepared as described hereinbelow.

Chain transfer agent 2 is 3-methoxybutyl 3-mercaptopropionate and was obtained from ABCR GmbH & Co. KG, Karlsruhe, Germany.

Chain transfer agent 3 is pentaerythritol tetrakis(3-mercaptobutylate) and was obtained from Showa Denko K. K., Kawasaki, Japan, under the name of Karenz MT PE-1.

Chain transfer agent 4 is pentaerythritol tetrakis(3-mercaptopropionate) and was obtained from Bruno Bock Chemische Fabrik GmbH & Co. KG, Marschacht, Germany.

Chain transfer agent 5 is n-dodecylthiol and was obtained from Chempur Feinchemikalien und Forschungsbedarf GmbH, Karlsruhe, Germany.

Photointitiator 1: New Methylene Blue 0.10% with CGI 909 (product from BASF SE, Basle, Switzerland) 1.0%, as solution in N-ethylpyrrolidone (NEP), NEP proportion 3.5%. Percentages are based on overall formulation of medium.

Photointitiator 2: Safranin O 0.10% with CGI 909 (product from BASF SE, Basle, Switzerland) 1.0%, as solution in N-ethylpyrrolidone (NEP), NEP proportion 3.5%. Percentages are based on overall formulation of medium.

Photointitiator 3: New Methylene Blue (salt-exchanged with dodecylbenzenesulphonate) 0.20%, Safranin O (salt-exchanged with dodecylbenzenesulphonate) 0.10% and Astrazon Orange G (salt-exchanged with dodecylbenzenesulphonate) 0.10% with CGI 909 (product from BASF SE, Basle, Switzerland) 1.5%, as solution in N-ethylpyrrolidone (NEP), NEP proportion 3.5%. Percentages are based on overall formulation of medium.

Catalyst 1: Fomrez® UL28 0.5%, urethanization catalyst, dimethylbis[(1-oxoneodecl)oxy]stannane, commercial product from Momentive Performance Chemicals, Wilton, Conn., USA (used as 10% solution in N-ethylpyrrolidone).

Byk® 310 (silicone-based surface additive from BYK-Chemie GmbH, Wesel, 25% solution in xylene) 0.3%.

Substrate 1: polyethylene terephthalate foil, 36 μm, type Hostaphan” RNK, from Mitsubishi Chemicals, Germany.

Substrate 2: Makrofol DE 1-1 CC 125 μm (Bayer MaterialScience AG, Leverkusen, Germany).

DMC catalyst: dual metal cyanide catalyst based on zinc hexacyanocobaltate (III), obtainable by the method described in EP 700 949 A.

Irganox 1076 is octadecyl 3,5-di-(tert)-butyl-4-hydroxyhydrocinnamate (CAS 2082-79-3).

### Methods of Measurement:

### OH Numbers

Reported OH numbers were determined in accordance with DIN 53240-2.

NCO values

Reported NCO values (isocyanate contents) were determined in accordance with DIN EN ISO 11909.

### Viscosities

To determine the viscosity of a component or mixture, the component or mixture was applied unless otherwise stated at 20° C. in a cone-plate measuring system of a rheometer (from Anton Paar Physica Modell MCR 51). The measurement was carried out under the following conditions:
measuring body: cone CP 25, d=25 mm, angle=1°
measuring gap between cone and plate: 0.047 mm
measuring time: 10 sec
determination of viscosity at a shear rate of 250 l/sec.

Measuring the Holographic Properties DE and an of Holographic Media Via Two-Beam Interference in Reflection Mode

To measure the holographic performance of the holographic film, the protective foil is peeled off and the holographic film is laminated with the photopolymer side onto a 1 mm thick glass plate of suitable length and width by applying a rubber roll under light pressure. This sandwich of glass and photopolymer foil can then be used to determine the holograph performance parameters DE and Δn.

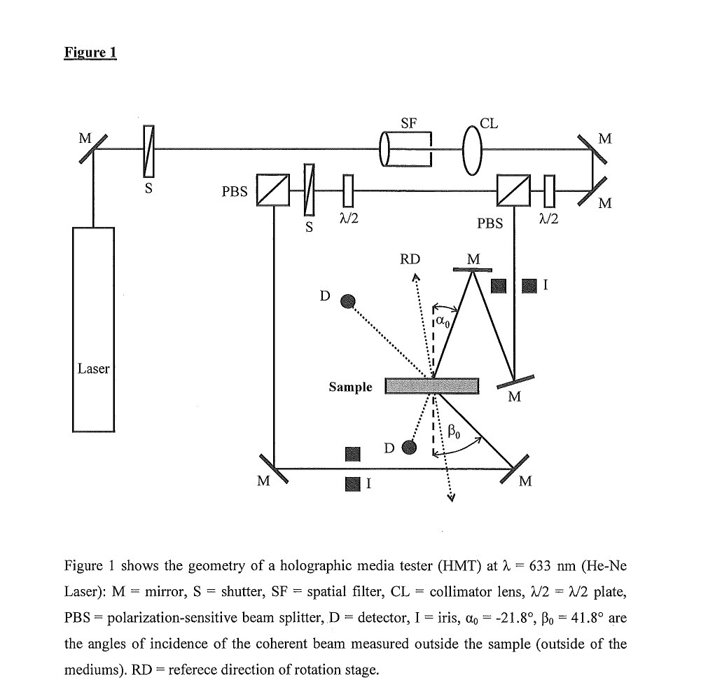

The beam of an He—Ne laser (emission wavelength 633 nm) was transformed via the spatial filter (SF) and together with the collimation lens (CL) into a parallel homogeneous beam. The final cross sections of the signal and reference beams are fixed via the iris diaphragms (I). The diameter of the iris diaphragm opening is 0.4 cm. The polarization-dependent beam splitters (PBS) split the laser beam into two coherent identically polarized beams. Via the λ/2 plates, the power of the reference beam was adjusted to 0.5 mW and the power of the signal beam to 0.65 mW. The powers were determined using the semiconductor detectors (D) with sample removed. The angle of incidence (α₀) of the reference beam is −21.8° and the angle of incidence (β₀) of the signal beam is 41.8°. The angles are measured from the sample normal to the beam direction. According to FIG. 1, therefore, α₀ has a negative sign and β₀ has a positive sign. At the location of the sample (medium), the interference field of the two overlapping beams produced a grating of light and dark strips which are perpendicular to the angle bisector of the two beams incident on the samples (reflection hologram). The strip spacing Λ, also referred to as grating period, in the medium is ˜225 nm (the refractive index of the medium is assumed to be ˜1.504).

FIG. 1 shows the holographic test construction, with which the diffraction efficiency (DE) of the media was tested.

Holograms were written into the medium in the following manner:
Both shutters (S) are open for the exposure time t.
Thereafter, with the shutters (S) closed, the medium was allowed 5 minutes for the diffusion of still unpolymerized writing monomers.

The written holograms were then read in the following manner. The shutter of the signal beam remained closed. The shutter of the reference beam was open. The iris diaphragm of the reference beam was closed to a diameter of <1 mm. This ensured that the beam was always completely in the previously written hologram for all angles (Ω) of rotation of the medium. The turntable, under computer control, then covered the angle range from Ωₘᵢₙ to Ωₘₐₓ with an angle step width of 0.05°. Ω is measured from the sample normal to the reference direction of the turntable. The reference direction of the turntable occurs when, during writing of the hologram, the angle of incidence of the reference beam and of the signal beam are of equal magnitude, i.e. α₀=−31.8° and β₀=31.8°. Ω_{recording} is then=0°. For α₀=−21.8° and β₀=41.8°, therefore, Ω_{recording} is 10°. The following is generally true for the interference field during writing (“recording”) of the hologram:

α₀=θ₀+Ω_{recording}.

θ₀ is the semiangle in the laboratory system outside the medium and the following is true during recording of the hologram:

$${θ}_{0} = \frac{{α}_{0} - {β}_{0}}{2} .$$

In this case, θ₀ is therefore −31.8°. At each angle Ω of rotation approached, the powers of the beam transmitted in the zeroth order were measured by means of the corresponding detector D and the powers of the beam diffracted in the first order were measured by means of detector D. The diffraction efficiency was obtained at each angle Ω approached as the quotient of:

$$η = \frac{{P}_{D}}{{P}_{D} + {P}_{T}}$$

P_{D} is the power in the detector of the diffracted beam and P_{T} is the power in the detector of the transmitted beam.

By means of the method described above, the Bragg curve (it describes the diffraction efficiency in as a function of the angle Ω of rotation) of the recorded hologram was measured stored in a computer. In addition, the intensity transmitted in the zeroth order was also recorded with respect to the angle Ω of rotation and stored in a computer.

The maximum diffraction efficiency (DE=ηₘₐₓ) of the hologram, i.e. its peak value, was determined at Ω_{reconstruction}. For this purpose, the position of the detector of the diffracted beam had to be changed, if necessary, in order to determine this maximum value.

The refractive index contrast Δn and the thickness d of the photopolymer layer were now determined by means of the Coupled Wave Theory (cf. H. Kogelnik, The Bell System Technical Journal, Volume 48, November 1969, Number 9, page 2909-page 2947) from the measured Bragg curve and the angle variation of the transmitted intensity. It should be noted that, owing to the thickness shrinkage occurring as a result of the photopolymerization, the strip spacing Λ′ of the hologram and the orientation of the strips (slant) may deviate from the strip spacing Λ of the interference pattern and the orientation thereof. Accordingly, the angle α₀′ or the corresponding angle of the turntable Ω_{reconstruction} at which maximum diffraction efficiency is achieved will also deviate from α₀ or from the corresponding Ω_{recording}, respectively. As a result, the Bragg condition changes. This change is taken into account in the evaluation method. The evaluation method is described below:

All geometrical quantities which relate to the recorded hologram and not to the interference pattern are represented as quantities shown by dashed lines.

According to Kogelnik, the following is true for the Bragg curve η(Ω) of a reflection hologram:

$$η = \{ \begin{matrix}\frac{1}{1 - \frac{1 - {( ξ / v )}^{2}}{{sin}^{2} ( \sqrt{{ξ}^{2} - {v}^{2}} )}} , for {v}^{2} - {ξ}^{2} < 0 \\ \frac{1}{1 + \frac{1 - {( ξ / v )}^{2}}{{sinh}^{2} ( \sqrt{{v}^{2} - {ξ}^{2}} )}} , for {v}^{2} - {ξ}^{2} \geq 0\end{matrix} \\ with \text{:} \\ v = \frac{π \cdot Δ n \cdot {d}^{′}}{λ \cdot \sqrt{\vert {c}_{s} \cdot {c}_{r} \vert}} \\ ξ = - \frac{{d}^{′}}{2 \cdot {c}_{s}} \cdot D P \\ {c}_{s} = cos ( {ϑ}^{′} ) - cos ( {ψ}^{′} ) \cdot \frac{λ}{n \cdot {Λ}^{′}} \\ {c}_{r} = cos ( {ϑ}^{′} ) \\ DP = \frac{π}{{Λ}^{′}} \cdot ( 2 \cdot cos ( {ψ}^{′} - {ϑ}^{′} ) - \frac{λ}{n \cdot {Λ}^{′}} ) \\ {ψ}^{′} = \frac{{β}^{′} + {α}^{′}}{2} \\ {Λ}^{′} = \frac{λ}{2 \cdot n \cdot cos ( {ψ}^{′} - {α}^{′} )}$$

When reading the hologram (“reconstruction”), the situation is analogous to that described above:

θ′₀=θ₀+Ω

sin(θ′₀)=n·sin(θ′)

Under the Bragg condition, the “dephasing” DP is 0. Accordingly, the following is true:

α′₀=θ₀+Ω_{reconstruction}

sin(α′₀)=n·sin(α′)

The still unknown angle β′ can be determined from the comparison of the Bragg condition of the interference field during recording of the hologram and the Bragg condition during reading of the hologram, assuming that only thickness shrinkage takes place. The following is then true:

$$sin ( {β}^{′} ) = \frac{1}{n} \cdot [ sin ( {α}_{0} ) + sin ( {β}_{0} ) - sin ( {θ}_{0} + {Ω}_{reconstruction} ) ]$$

ν is the grating thickness, ξ is the detuning parameter and ψ′ is the orientation (slant) of the refractive index grating which was recorded. α′ and β′ correspond to the angles α₀ and β₀ of the interference field during recording of the hologram, but measured in the medium and applicable to the grating of the hologram (after thickness shrinkage). n is the mean refractive index of the photopolymer and was set at 1.504. λ is the wavelength of the laser light in vacuo.

The maximum diffraction efficiency (DE=ηₘₐₓ) for ξ=0 is then:

$$D E = tan {h}^{2} ( v ) = tan {h}^{2} ( \frac{π \cdot Δ n \cdot {d}^{′}}{λ \cdot \sqrt{cos ( {α}^{′} ) \cdot cos ( {α}^{′} - 2 ψ )}} )$$

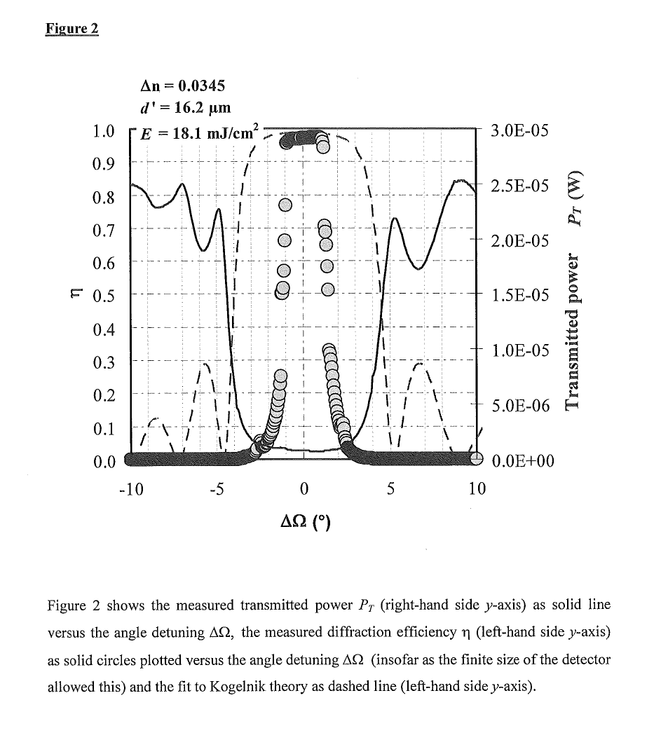

The measured data of the diffraction efficiency, the theoretical Bragg curve and the transmitted intensity are plotted against the centred angle of rotation ΔΩ≡Ω_{reconstruction}−Ω=α′₀−θ′₀, also referred to as angle detuning, as shown in FIG. 2.

Since DE is known, the shape of the theoretical Bragg curve according to Kogelnik is determined only by the thickness d′ of the photopolymer layer. Δn is corrected via DE for a given thickness d′ so that measurement and theory of DE always agree. d′ is now adjusted until the angular positions of the first secondary minima of the theoretical Bragg curve correspond to the angular positions of the first secondary maxima of the transmitted intensity and further-more the full width at half maximum (FWHM) for the theoretical Bragg curve and for the transmitted intensity correspond.

Since the direction in which a reflection hologram rotates on reconstruction by means of an Ω scan, but the detector for diffracted light can capture only a finite angular range, the Bragg curve of broad holograms (small d′) is not completely captured with an Q scan, but only the central region, with suitable detector positioning. The shape of the transmitted intensity which is complementary to the Bragg curve is therefore additionally used for adjusting the layer thickness d′.

FIG. 2 shows the plot of the Bragg curve η according to the Coupled Wave Theory (dashed line), the measured diffraction efficiency (solid circles) and the transmitted power (black solid line) against the angle detuning ΔΩ.

For one formulation, this procedure was possibly repeated several times for different exposure times t on different media in order to determine at which mean energy dose of the incident laser beam during recording of the hologram DE the saturation value is reached. The mean energy dose E is obtained as follows from the powers of the two partial beams coordinated with the angles α₀ and β₀ (reference beam with Pᵣ=0.50 mW and signal beam with Pₛ=0.63 mW), the exposure time t and the diameter of the iris diaphragm (0.4 cm):

$$E ( mJ \text{/} {cm}^{2} ) = \frac{2 \cdot [ {P}_{r} + {P}_{s} ] \cdot t ( s )}{π \cdot {0.4}^{2 } {cm}^{2}}$$

The powers of the partial beams were adjusted so that, at the angles α₀ and β₀ used, the same power density is reached in the medium.

Measuring the Thickness of Photopolymer Layers in Photopolymer Films

Physical layer thickness was determined using commercially available white light interferometers, for example an FTM-Lite NIR layer thickness measuring instrument from Ingenieursbüro Fuchs.

Layer thickness determination is based in principle on interference phenomena at thin layers. Lightwaves reflected at two interfaces of differing optical density become superposed. Undisturbed superposition of reflected part-beams then leads to periodic brightening and extinction in the spectrum of a white continuum radiator (e.g. halogen lamp). This superposition is referred to as interference by a person skilled in the art. These interference spectra are measured and mathematically evaluated.

Determination of Scatter Using Media Scatter Tester

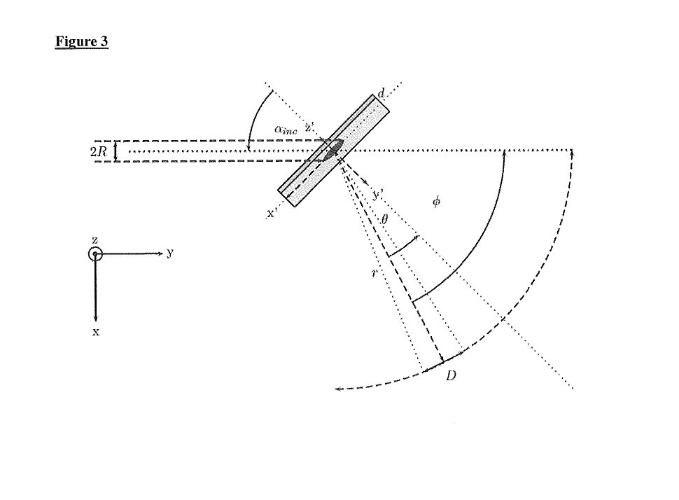

The MST consists of a collimated laser beam as light source (available wavelengths 657 nm and 405 nm, beam diameter 2R=0.32 mm for 657 nm and 2.19 mm for 405 nm), a sample holder and a detection unit consisting of a photodiode coupled to a lock-in amplifier. The detection unit is mounted on a swing arm which is able to sweep an areal quadrant. The geometries involved in the media scatter tester are shown in FIG. 3.

The scattering angle φ in the lab coordinate system can be varied between 0° and 90° using the swing arm. The sample is oriented such that the laser beam coming from the left and the projection of the normal on the surface of the sample into the scattering plane forms an angle αinc=50°. The sample is additionally tilted by the angle ψ=8° from the vertical direction in the lab system. This angle ψ is not depicted in FIG. 3. The linear polarizing direction of the red laser light (657 nm) is parallel to the z-axis in the lab system (S-polarization). For the blue laser, the linear direction of polarization is parallel to the x, y-plane (P-polarization). The spatial angle Ω_{Sc} subsumed by the detector is given by:

$${Ω}_{Sc} = \frac{π \cdot {( D / 2 )}^{2}}{{r}^{2}} \qquad ( 1 )$$

D is the diameter of the iris diaphragm in front of the photodiode and r is the distance between this iris and the sample. d is the thickness of the sample (here, the thickness of the active holographic photopolymer). The bidirectional scattering distribution function BSDF is defined for direct evaluation and representation of angle-dependent scattering:

$$BDSF = \frac{{P}_{Sc} / {Ω}_{Sc}}{{P}_{inc} \cdot cos ( θ )}$$

P_{Sc} is the power which is incident in the spatial angle element Ω_{Sc} and which is measured with the photodiode at the lock-in amplifier. P_{inc} is the incident laser power on the sample and 1/cos (θ) corrects the cross section of the scatter volume defined by the incident beam, which the detector sees as a function of the scattering angle φ in the lab system. The BSDF is reported in 1/srad and is a measure of the scatter power of the sample. To determine BSDF, the samples were first homogeneously photopolymerized under a UV lamp from Hoenle (illuminant: MH lamp UV-400 H, dose 5 J/cm²). To this end, the protective foil on the holographic film samples was peeled off and the holographic film was laminated with the photopolymer side onto a 1 mm thick glass plate of suitable length and width, using a rubber roll under light pressure. This sandwich of glass and photopolymer foil can then be used to determine BSDF after UV exposure. The coupon samples were used in the as-prepared state for UV exposure and later BSDF determination. A sample which on homogeneous UV exposure form high adventitious concentration fluctuations and high molecular weights then exhibit a high BSDF.

The Angle Scan mode of measurement measures the BSDF per angular increment at a point over an angular range φ from 10° to 90°. What is determined in fact is the BSDF mean between 50° and 90°.

The Map mode of measurement measures the BSDF at the scatter angle φ=70° and scans the beam over a range of 2.5×2.5 mm² using a step increment of 0.5 mm.

### Preparation of Substances:

### Preparation of Polyol 1:

A 1 L flask was initially charged with 0.18 g of tin octoate, 374.8 g of ε-caprolactone and 374.8 g of a difunctional polytetrahydrofuran polyetherpolyol (equivalent weight 500 g/mol OH) before heating to 120° C. and maintaining this temperature until the solids content (fraction of nonvolatiles) was 99.5 wt % or higher. This was followed by cooling to obtain the product as a waxy solid.

### Preparation of Polyol 2

A reactor was charged with 2475 g of a difunctional polytetrahydrofuran polyetherpolyol (equivalent weight 325 g/mol OH) followed by 452.6 mg of DMC catalyst. The temperature was then raised to 105° C. while stirring at about 70 rpm. Vacuum was applied by threefold application of vacuum and venting with nitrogen, and the stirrer was set to 300 rpm. N₂ was upwardly passed through the mixture at a flow of 0.1 bar for 57 minutes before an N₂ pressure of 0.5 bar was established and 100 g of ethylene oxide (EO) and 150 g of propylene oxide (PO) were introduced concurrently (pressure rises to 2.07 bar) to start the polymerization. After 10 minutes, the pressure had gone back down to 0.68 bar and a further 5.116 kg of EO and also 7.558 kg of PO were introduced at 2.34 bar over 1 h 53 min. 31 minutes after completion of PO addition, vacuum was applied at a residual pressure of 2.16 bar for complete degassing. The product was stabilized by addition of 7.5 g of Irganox 1076 to obtain a viscous (1636 mPas) liquid (OH number 27.1 mg KOH/g).

### Preparation of Polyol 3:

A reactor was charged with 2465 g of a difunctional polytetrahydrofuran polyetherpolyol (equivalent weight 325 g/mol OH) followed by 450.5 mg of impact catalyst. The temperature was then raised to 105° C. while stirring at about 70 rpm. Vacuum was applied by threefold application of vacuum and venting with nitrogen, and the stirrer was set to 300 rpm. N₂ was upwardly passed through the mixture at a flow of 0.1 bar for 72 minutes before an N₂ pressure of 0.3 bar was established and 242 g of propylene oxide (PO) were introduced concurrently (pressure rises to 2.03 bar) to start the polymerization. After 8 minutes, the pressure had gone back down to 0.5 bar and a further 12.538 kg of PO were introduced at 2.34 bar over 2 h 11 min. 17 minutes after completion of PO addition, vacuum was applied at a residual pressure of 1.29 bar for complete degassing. The product was stabilized by addition of 7.5 g of Irganox 1076 to obtain a colourless viscous (1165 mPas) liquid (OH number 27.8 mg KOH/g).

### Preparation of writing monomer 1 (phosphorus thioyltris(oxy-4,1-phenyleneiminocarbonyloxyethane-2,1-diyl)triacrylate)

In a 500 mL round-bottom flask, 0.1 g of 2,6-di-tert-butyl-4-methylphenol, 0.05 g of dibutyltin dilaurate (Desmorapid® Z, Bayer MaterialScience AG, Leverkusen, Germany) and also 213.07 g of a 27% solution of tris(p-isocyanatophenyl)thiophosphate in ethyl acetate (Desmodur® RFE, product from Bayer MaterialScience AG, Leverkusen, Germany) were initially charged and heated to 60° C. Thereafter, 42.37 g of 2-hydroxyethyl acrylate were added dropwise and the mixture was further maintained at 60° C. until the isocyanate content had dropped below 0.1%. This was followed by cooling and complete removal of the ethyl acetate under reduced pressure to obtain the product as a partly crystalline solid.

### Preparation of writing monomer 2 (2-({[3-(methylsulphanyl)phenyl]-carbamoyl}oxy)ethyl prop-2-enoate)

In a 100 mL round-bottom flask, 0.02 g of 2,6-di-tert-butyl-4-methylphenol, 0.01 g of Desmorapid® Z, 11.7 g of 3-(methylthio)phenyl isocyanate were initially charged and heated to 60° C. Thereafter, 8.2 g of 2-hydroxyethyl acrylate were added dropwise and the mixture was further maintained at 60° C. until the isocyanate content had dropped below 0.1%. This was followed by cooling to obtain the product as a pale yellow liquid.

### Preparation of additive 1 (bis(2,2,3,3,4,4,5,5,6,6,7,7-dodecafluoroheptyl) 2,2,4-trimethylhexane-1,6-diyl biscarbamate)

In a 2000 mL round-bottom flask, 0.02 g of Desmorapid® Z and 3.6 g of 2,4,4-trimethylhexanes-1,6-diisocyanate (TMDI) were initially charged and heated to 70° C. This was followed by the dropwise addition of 11.39 g of 2,2,3,3,4,4,5,5,6,6,7,7-dodecafluoroheptan-1-ol and the mixture was further maintained at 70° C. until the isocyanate content had dropped below 0.1%. This was followed by cooling to obtain the product as a colourless oil.

### General Method of Producing Media as Glass Coupons:

To produce holographic media, the writing monomers B), the stabilizers, which may already be predissolved in component B), and also optionally the auxiliary and admixture agents were dissolved in the employed polyol (isocyanate-reactive component b)) optionally at 60° C., at which point glass beads 10 μm in size from Whitehouse Scientific Ltd, Waverton, Chester, CH3 7PB, United Kingdom were added and thoroughly mixed. Thereafter, in the dark or under suitable illumination, the photoinitiator(s) C) was/were weighed out followed again by 1 minute of mixing. If necessary, the mixture was heated in a drying cabinet to 60° C. for not more than 10 minutes. Then, the isocyanate component a1) was added which was again followed by mixing for 1 minute. Thereafter, a solution of catalyst D) was added which was again followed by 1 minute of mixing. The mixture obtained was degassed under agitation at <1 mbar for not more than 30 seconds, then it was distributed on glass plates of 50×75 mm and these each covered with a further glass plate. The formulation was cured under 15 kg weights overnight. The thickness d of the photopolymer layer resulted from the 10 μm diameter of the glass balls used. Since different formulations with differing starting viscosity and differing curing rate on the part of the matrix did not always lead to the same layer thicknesses d for the photopolymer layer, d was ascertained separately for each sample from the characteristics of the written holograms.

This method was followed to produce the media of Comparative Examples V1 to V3 and of Inventive Examples 1 to 5.

| Comparative | | | | | | | | | | |
|---|---|---|---|---|---|---|---|---|---|---|
| Example or | | | Isocyanate | | Writing | | Writing | | | |
| Inventive | Polyol | Fraction | component | Fraction | monomer No. | Fraction | monomer No. | Fraction | Additive | Fraction |
| Example No. | No. | (wt %) | No. | (wt %) | (1st monomer) | (wt %) | (2nd monomer) | (wt %) | No. | (wt %) |
| V1 | 1 | 33.8 | 1 | 6.4 | 1 | 25 | 2 | 15 | 1 | 15 |
| 1 | 1 | 33.4 | 1 | 6.4 | 1 | 25 | 2 | 15 | 1 | 15 |
| 2 | 1 | 33.7 | 1 | 6.5 | 1 | 25 | 2 | 15 | 1 | 15 |
| 3 | 1 | 33.7 | 1 | 6.5 | 1 | 25 | 2 | 15 | 1 | 15 |
| V2 | 2 | 35.4 | 2 | 4.8 | 1 | 25 | 2 | 15 | 1 | 15 |
| 4 | 2 | 35.7 | 2 | 4.5 | 1 | 25 | 2 | 15 | 1 | 15 |
| V3 | 3 | 49.0 | 2 | 6.3 | 1 | 20 | 2 | 20 | — | — |
| 5 | 3 | 48.9 | 2 | 6.3 | 1 | 20 | 2 | 20 | — | — |

| Comparative | | | | | | | Angle Scan | | |
|---|---|---|---|---|---|---|---|---|---|
| Example or | Chain | | Photo- | | | Layer | (405 nm), | Map | Map |
| Inventive | transfer | Fraction | initiator | Catalyst 1 | Δn | thick- | <50°-90° > × | (405 nm) × | (657 nm) × |
| Example No. | agent No. | (wt %) | No. | (wt %) | (max.) | ness/μm | 10⁵ 1/srad | 10⁵ 1/srad | 10⁵ 1/srad |
| V1 | — | — | 1 | 0.02 | 0.0324 | 22 | 122.1 | 116.7 | 103.7 |
| 1 | 2 | 0.5 | 1 | 0.02 | 0.0352 | 14 | 91.5 | 93.3 | 45.8 |
| 2 | 3 | 0.1 | 1 | 0.02 | 0.0304 | 16 | 55.6 | 70.5 | 99.7 |
| 3 | 4 | 0.1 | 1 | 0.02 | 0.0318 | 21 | 92.7 | 66.8 | |
| V2 | — | — | 1 | 0.02 | 0.0365 | 17 | | 105.4 | 52.2 |
| 4 | 5 | 0.1 | 1 | 0.02 | 0.0400 | 19 | | 102.0 | 47.4 |
| V3 | — | — | 2 | 0.02 | 0.0150 | 16 | 76.1 | 76.4 | 81.4 |
| 5 | 5 | 0.1 | 2 | 0.02 | 0.0251 | 13 | 43.8 | 42.8 | 36.4 |

Comparing the media from inventive photopolymer formulations 1 to 3 with the medium from the formulation of Comparative Example V1 (i.e. Inventive Example 4 vs Comparative Example 2 and Inventive Example 5 vs Comparative Example 3) shows that media produced using the inventive photopolymer formulations have reduced scatter on exposure.

### Film Samples:

In addition to the composition of the photopolymer formulation, the substrate used also has an influence on the scatter in the holographic medium. Therefore, the exemplified media were each compared on the same substrate foil.

### Comparative Example 4

331.5 g of polyol 1 were incrementally admixed in the dark with 150.0 g of writing monomer 1, 150.00 g of writing monomer 2 and 250.0 g of additive 1, then 1.00 g of catalyst 1 and 3.0 g of Byk® 310 and finally 53.1 g of photoinitiator 3 to obtain a clear solution. Then 61.4 g of isocyanate component 1 were admixed at 30° C. The liquid mass obtained was then applied to substrate 1 and dried at 80° C. for 4.5 minutes. Dry layer thickness: 18.5 μm. Δn(max.) (633 nm)=0.0331.

### Comparative Example 5

6.6 g of polyol 1 were incrementally admixed in the dark with 3.25 g of writing monomer 1, 3.25 g of writing monomer 2 and 4.5 g of additive 1, then 0.060 g of catalyst 1 and 0.060 g of Byk® 310 and finally 1.026 g of photoinitiator 3 to obtain a clear solution. Then 1.248 g of isocyanate component 1 were admixed at 30° C. The liquid mass obtained was then applied to substrate 2 and dried at 80° C. for 10.3 minutes. Dry layer thickness: 16.5 μm. Δn(max.) (633 nm)=0.0263.

### Inventive Example 6

6.6 g of polyol 1 were incrementally admixed in the dark with 3.0 g of writing monomer 1, 3.0 g of writing monomer 2, 5.0 g of additive 1 and 0.02 g of additive 6, then 0.020 g of catalyst 1 and 0.060 g of Byk® 310 and finally 1.06 g of photoinitiator 3 to obtain a clear solution. Then 1.265 g of isocyanate component 1 were admixed at 30° C. The liquid mass obtained was then applied to substrate 1 and dried at 80° C. for 7.7 minutes. Dry layer thickness: 17 μm. Δn(max.) (633 nm)=0.0325.

### Inventive Example 7

6.5 g of polyol 1 were incrementally admixed in the dark with 3.25 g of writing monomer 1, 3.25 g of writing monomer 2, 4.5 g of additive 1 and 0.1 g of additive 6, then 0.060 g of catalyst 1 and 0.060 g of Byk® 310 and finally 1.026 g of photoinitiator 3 to obtain a clear solution. Then 1.232 g of isocyanate component 1 were admixed at 30° C. The liquid mass obtained was then applied to substrate 2 and dried at 80° C. for 10.3 minutes. Dry layer thickness: 18.5 μm. Δn(max.) (633 nm)=0.0303.

| Comparative | | | | | | | | | | |
|---|---|---|---|---|---|---|---|---|---|---|
| Example or | | | Isocyanate | | Writing | | Writing | | | |
| Inventive | Polyol | Fraction | component | Fraction | monomer No. | Fraction | monomer No. | Fraction | Additive | Fraction |
| Example No. | No. | (wt %) | No. | (wt %) | (1st monomer) | (wt %) | (2^{nd} monomer) | (wt %) | No. | (wt %) |
| V4 | 1 | 33.2 | 1 | 6.1 | 1 | 15 | 2 | 15 | 1 | 25 |
| 6 | 1 | 32.9 | 1 | 6.3 | 1 | 15 | 2 | 15 | 1 | 25 |
| V5 | 1 | 33.0 | 1 | 6.2 | 1 | 16.3 | 2 | 16.3 | 1 | 22.5 |
| 7 | 1 | 32.6 | 1 | 6.2 | 1 | 16.3 | 2 | 16.3 | 1 | 22.5 |

| Comparative | | | | | | | Angle Scan | | |
|---|---|---|---|---|---|---|---|---|---|
| Example or | Chain | | Photo- | | | Layer | (405 nm), | Map | Map |
| Inventive | transfer | Fraction | initiator | Catalyst 1 | Δn | thick- | <70° > × | (405 nm) × | (657 nm) × |
| Example No. | agent No. | (wt %) | No. | (wt %) | (max.) | ness/μm | 10⁵ 1/srad | 10⁵ 1/srad | 10⁵ 1/srad |
| V4 | — | — | 3 | 0.1 | 0.0331 | 18.5 | 191.3 | 374.6 | 184.6 |
| 6 | 5 | 0.1 | 3 | 0.1 | 0.0325 | 17.0 | 79.3 | 136.1 | 84.6 |
| V5 | — | — | 3 | 0.3 | 0.0263 | 16.5 | 6.3 | 6.3 | |
| 7 | 4 | 0.5 | 3 | 0.3 | 0.0303 | 18.5 | 5.3 | 5.5 | |

Comparing the media from inventive photopolymer formulations 6 and 7 with the media from the formulations of Comparative Examples V4 and V5 shows that media produced using the inventive photopolymer formulations each have a reduced scatter after exposure depending on the substrate used.

1-15. (canceled)

16. A photopolymer formulation comprising at least a matrix polymer A), obtained by at least a polyisocyanate component a) and an isocyanate-reactive component b) being reacted, a writing monomer B), a photo-initiator C) and a catalyst D), wherein the photopolymer formulation comprises a sulphur-containing chain transfer agent E).

17. The photopolymer formulation according to claim 16, wherein the sulphur-containing chain transfer agent E) comprises one or more compounds selected from the group of monofunctional thiols and multifunctional thiols.

18. The photopolymer formulation according to claim 16, wherein the sulphur-containing chain transfer agent E) comprises one or more compounds selected from the group consisting of mono-, di- and multifunctional primary thiols and difunctional secondary thiols.

19. The photopolymer formulation according to claim 16, wherein the chain transfer agent E) comprises one or more compounds selected from the group consisting of n-octylthiol, n-hexylthiol, n-decylthiol, n-dodecylthiol, 11,11-dimethyldodecane-1-thiol, 2-phenylethyl mercaptan, 1,8-dithionaphthalene, octane-1,8-dithiol, 3,6-dioxa-1,8-octanedithiol, cyclooctane-1,4-dithiol, 3-methoxybutyl 3-mercaptopropionate, 2-ethylhexyl thioglycolate, 2-ethylhexyl 3-mercaptopropionate, isooctyl thioglycolate, isotridecyl thioglycolate, glycol di(3-mercaptopropionate), glycol dimercaptoacetate, pentaerythritol tetrakis(mercaptoacetate), pentaerythritol tetrakis(mercaptopropionate), trimethylolpropane tris(2-mercaptoacetate), trimethylolpropane tris(3-mercaptopropionate), 1,4-bis(3-mercaptobutylyloxy)butane, 1,3,5-tris(3-mercaptobutyloxyethyl)-1,3,5-triazine-2,4,6(1H,3H,5H)-triones, pentaerythritol tetrakis(3-mercaptobutylate), 2,2′-[ethane-1,2-diylbis(oxy)]diethanethiol, 2,2′-oxydiethanethiol, 2-thionaphthol, mercaptobenzothiazole, 2-mercaptobenzoxazole, mercaptobenzimidazole, 4-methylbenzyl mercaptan, 2-mercaptoethyl sulphide, bis(phenylacetyl)disulphide, dibenzyl disulphide, di-tert-butyl disulphide, phenothiazine and triphenylmethanethiol.

20. The photopolymer formulation according claim 16, wherein the photopolymer formulation comprises 0.01 wt % to 1 wt % of the sulphur-containing chain transfer agent E).

21. The photopolymer formulation according to claim 16, wherein the writing monomer B) comprises a mono- and/or a multifunctional acrylate.

22. The photopolymer formulation according to claim 16, wherein the catalyst D) comprises at least a compound of general formulae R²Sn(IV)L₃ and L₂Sn(IV)R²₂, where R² is a linear or branched alkyl moiety of 1-30 carbon atoms which is optionally substituted with heteroatoms, and L independently in each occurrence represents ⁻O₂C—R³ groups in each of which R³ is a linear or branched alkyl moiety of 1-30 carbon atoms optionally substituted with heteroatoms, an alkenyl moiety of 2-30 carbon atoms or any desired substituted or unsubstituted optionally polycyclic aromatic ring with or without heteroatoms.

23. The photopolymer formulation according to claim 16, wherein the photopolymer formulation additionally contains an additive F).

24. The photopolymer formulation according to claim 23, wherein the additive F) comprises at least a compound of general formula (VII) 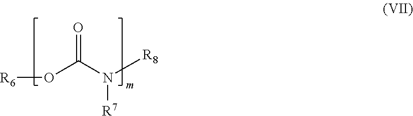
where m is ≧1 and m is ≦8 and R⁴, R⁵, R⁶ are each independently hydrogen, linear, branched, cyclic or heterocyclic organic moieties which are unsubstituted or optionally substituted with heteroatoms.

25. A holographic medium comprising a photopolymer formulation according to claim 16 or obtained using a photopolymer formulation according to claim 16.

26. The holographic medium according to claim 25, comprising a film in the photopolymer formulation.

27. The holographic medium according to claim 26, comprising a covering layer and/or a carrier layer which are optionally each connected at least regionally to the film.

28. The holographic medium according to claim 25, wherein a hologram has been exposed into the holographic medium.

29. A method for producing holographic media comprising utilizing the photopolymer formulation according to claim 16.

30. A process for producing a holographic medium, comprising
(I) producing the photopolymer formulation according to claim 16 by mixing all constituents,
(II) introducing the photopolymer formulation at a processing temperature into a form desired for the holographic medium, and
(III) curing the photopolymer formulation in the form at a crosslinking temperature above the processing temperature with urethane formation,
wherein the processing temperature is ≧15 and ≦40° C. and the crosslinking temperature is ≧60° C. and ≦100° C.
